(19) United States
(12) Patent Application Publication
(10) Pub. No.: US 2013/0260980 A1
(43) Pub. Date: Oct. 3, 2013

(54) SYSTEMS AND METHODS FOR FORMING GLASS MATERIALS

(71) Applicants: Robert D. Touslee, Littleton, CO (US); Elam A. Leed, Littleton, CO (US)

(72) Inventors: Robert D. Touslee, Littleton, CO (US); Elam A. Leed, Littleton, CO (US)

(21) Appl. No.: 13/435,801

(22) Filed: Mar. 30, 2012

(51) Int. Cl. C03C 13/00; C03B 37/02; C03B 5/16; C03C 3/12; F23G 7/06; C10L 8/00; C03C 3/076; C03C 3/06; C03B 37/04; F27B 14/00

(52) U.S. Cl. 501/35; 65/469; 65/478; 65/483; 432/13; 432/62; 44/628; 501/55; 501/54; 501/41

(57) ABSTRACT

Methods for forming glass compositions from cullet include providing the cullet to a submerged combustion melter and melting the cullet with the aid of heat generated upon the combustion of a hydrocarbon from landfill gas and, in some cases, a polymeric material, in the presence of an oxidant. The melted cullet is then directed to a fiberization unit to generate a glass composition, such as vitreous fiber. The glass composition can be used to form various structural components, such as glass fiber insulation. Methods and systems provided herein can be used to form low global warming potential products.

### BACKGROUND OF THE INVENTION

Vitreous fiber and other forms of glass product can be produced from cullet, or post-consumer glass that is often destined for landfills. Cullet is heated until it melts, and the fiber is then formed via a process such as cascade fiberization. Vitreous fiber has many important applications, such as in building and industrial insulation.

In some cases, vitreous fiber can be adapted for use in composites, wallboards or other structural components. Vitreous fiber can have properties that are suited for providing thermal and acoustical insulation in residential and industrial settings.

### SUMMARY OF THE INVENTION

The present invention provides methods and systems for producing vitreous fiber (herein also “fiber glass”) materials from cullet, and for providing fuel compositions for effecting the production of vitreous fiber from cullet. Some of the methods of the present invention utilize submerged combustion melting in a submerged combustion melter (SCM) using landfill gas as part of the fuel mixture for generating heat for melting cullet. In some embodiments, landfill gas is a methane-containing gas that results from degradation processes in landfills. Landfill gas may be considered a greenhouse gas, as well as a tropospheric ozone precursor. It would be advantageous to capture landfill gas for productive applications as a fuel because methane is in fact significantly worse for the earth atmosphere than carbon dioxide, the most recognized greenhouse gas. Some of the methods of the present invention utilize landfill gas in combination with other fuel components, such as polymers, to produce heat by combustion, such as upon reaction of fuel with an oxidant. Combustion generates heat that is sufficient to melt cullet to a molten mass, which may be subsequently used to produce vitreous fiber.

Utilization of landfill gas to produce vitreous fibers offers many advantageous features related to the preservation of the environment and energy conservation, including: 1) conversion of a potent greenhouse gas (e.g., methane) into a gas (e.g., carbon dioxide) that has an impact on climate change that is about 20 times less than that of methane; 2) use of waste and post-consumer materials (e.g., landfill gas, bottle glass and optionally plastics) and commensurate reduction in landfill volumes; and 3) improvement of energy efficiency through insulation products made from vitreous fibers made with the aid of methods, systems, and fuels provided herein.

In an aspect of the invention, a method for producing a glass composition is provided, comprising providing cullet to a submerged combustion melter, melting the cullet in the submerged combustion melter to form a molten composition, where the cullet is melted with the aid of heat generated by the reaction of a fuel mixture with an oxidant, and where the fuel mixture comprises a hydrocarbon from landfill gas, and producing the glass composition from the molten composition. In an embodiment, the glass composition is a glass fiber. In another embodiment, the hydrocarbon includes methane. In another embodiment, the providing comprises sourcing the cullet from a mixed post-consumer stream. In another embodiment, the landfill gas comprises at least about 30% carbon dioxide and is extracted from a landfill where anaerobic digestion produced the landfill gas from post-consumer waste. In another embodiment, the fuel mixture further comprises a polymeric material. In another embodiment, the polymeric material is recycled or post-consumer plastic. In another embodiment, the plastic is polyethylene terephthalate. In another embodiment, the plastic is high-density polyethylene. In another embodiment, the plastic is selected from the group consisting of low-density polyethylene, polypropylene, or polystyrene. In another embodiment, the oxidant comprises at least about 50% by volume oxygen. In another embodiment, the oxidant comprises at least about 90% by volume oxygen produced in an air separation unit. In another embodiment, the producing comprises directing the molten composition to a rotary fiberizer downstream of the submerged combustion melter. In another embodiment, the producing comprises directing the molten composition to a cascade fiberizer downstream of the submerged combustion melter. In another embodiment, one or more materials selected from the group consisting of silica sand, limestone, burnt lime, dolomitic lime, burnt dolomitic lime, soda ash, borax, colemanite, and ulexite to form a vitrifiable batch added to the feed or directly to the molten composition. In another embodiment, the submerged combustion furnace is disposed on or adjacent to a landfill.

In another aspect of the invention, a low global warming potential (GWP) glass material is formed. In an embodiment, the low GWP material is glass fiber having a biosolubility of at least 100 ng/cm²/hr, a difference between the liquidus temperature and the high-temperature viscosity (HTV) value of at least 50° F., a softening point of at least 650° C.; a moisture resistance (G_{hyd}) more positive than −8.0 kcal/mole, produced from a vitrifiable batch comprising at least 80% post-consumer cullet and an SiO₂ content of greater than 66% by weight is provided. In an embodiment, the low GWP glass material has the biosolubility of at least about 200 ng/cm²/hr, and the difference in liquidus temperature and HTV value of at least about 100° F. In another embodiment, the HTV value of the low GWP glass is at most about 2150° F. In another embodiment, the low GWP material is produced from a vitrifiable batch comprising at least about 95% glass cullet. In another embodiment, the liquidus temperature of the low GWP glass material is at most about 2050° F. In another embodiment of the process, at least about 50 carbon dioxide equivalents are destroyed per pound of the low GWP energy glass material formed. In another embodiment, greenhouse gas emission credits are obtained for destroying the carbon dioxide equivalents, which credits may be tradable on a financial exchange.

In another aspect of the invention, a fibrous glass composition is formed from at least about 66% SiO₂ by weight, and no more than about 2% B₂O₃ by weight. In an embodiment, the fibrous glass composition comprises no more than 0.5% B₂O₃ by weight of the boron-containing material. In another embodiment, the fibrous glass composition comprises at least about 68% SiO₂ by weight. In another embodiment, the fibrous glass composition is made from a batch comprising a lime-containing material. In another embodiment, the lime-containing material is quicklime. In another aspect of the invention, a fibrous glass composition sourced from at least about 97% cullet by weight is provided.

In another aspect of the invention, a system for producing a glass composition comprises a submerged combustion melter, where the submerged combustion melter in fluid communication with a source of landfill gas from a landfill. In an embodiment, the system further comprises a mineral source upstream of the submerged combustion melter, where the mineral source supplies to the submerged combustion melter one or more materials selected from the group consisting of silica sand, limestone, burnt lime, dolomitic lime, burnt dolomitic lime, soda ash, borax, colemanite, and ulexite. In another embodiment, the glass composition is fiberized. In another embodiment, the system further comprises a fiberizer downstream of the submerged combustion melter, where the fiberizer accepts molten glass from the submerged combustion melter and generates the glass fibers. In another embodiment, the submerged combustion melter is disposed on or adjacent to a landfill. In another embodiment, the submerged combustion melter is configured to accept cullet from a post-consumer source.

In another aspect of the invention, a method of inerting a tropospheric ozone precursor is provided, comprising collecting an ozone precursor resulting from degradation of post-consumer waste, delivering the precursor to a combustion zone under a molten mass, and reacting the precursor with an oxidizer, where the reacting constitutes inerting the high GWP ozone precursor, and also liberates heat, where the heat is utilized to generate or maintain the molten mass. As used herein, “inerting” means to significantly reduce the GWP of a composition or molecule through reaction or conversion to a form having lesser GWP. In an embodiment, the precursor comprises methane derived from a landfill. In another embodiment, the molten mass is a vitreous mass at a temperature of at least 1800° F. In another embodiment, the oxidizer comprises at least about 50% oxygen gas by volume. In another embodiment, at least about 80% by weight cullet and a batch comprising a lime containing material are provided to a submerged combustion melter to form the glass composition. In another embodiment, the lime-containing material is quicklime.

Additional aspects and advantages of the present disclosure will become readily apparent to those skilled in this art from the following detailed description, wherein only illustrative embodiments of the present disclosure are shown and described. As will be realized, the present disclosure is capable of other and different embodiments, and its several details are capable of modifications in various obvious respects, all without departing from the disclosure. Accordingly, the drawings and description are to be regarded as illustrative in nature, and not as restrictive.

### INCORPORATION BY REFERENCE

All publications, patens, and patent applications mentioned in this specification are herein incorporated by reference to the same extent as if each individual publication, patent, or patent application was specifically and individually indicated to be incorporated by reference.

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings of which:

FIG. 1 schematically illustrates a process for forming molten glass and fibrous products from cullet using landfill gas as fuel, in accordance with an embodiment of the invention;

FIG. 2a schematically illustrates a submerged combustion melter (SCM), along with a glass conditioning unit, in accordance with an embodiment of the invention;

FIG. 2b schematically illustrates a top-down view of an SCM, along with entrance to a glass conditioning unit, in accordance with an embodiment of the invention;

FIG. 3 schematically illustrates a system for collecting landfill gas from a landfill, in accordance with an embodiment of the invention; and

FIG. 4 depicts landfill gas (LFG) collection piping, in accordance with an embodiment of the invention.

### DETAILED DESCRIPTION OF THE INVENTION

While various embodiments of the invention have been shown and described herein, it will be obvious to those skilled in the art that such embodiments are provided by way of example only. Numerous variations, changes, and substitutions may occur to those skilled in the art without departing from the invention. It should be understood that various alternatives to the embodiments of the invention described herein may be employed while still practicing the invention.

The term “fuel,” as used herein, means a combustible composition comprising a hydrocarbon, such as an alkane, alkene, alkyne, alcohol, or combinations thereof. In some cases, fuel includes one or more of methane, ethane, propane, butane, atomized oil, molten polymers or the like. In some situations, a fuel has at least about 40%, 50%, 60%, 70%, 80%, 90%, or 95% hydrocarbon. A fuel in some cases is provided by way of natural gas, which includes a major proportion of methane. Fuels as used herein can include minor amounts of non-fuel components, including oxidants. Non-fuel components can include inert substances (e.g., N₂, He, Ar), carbon monoxide, carbon dioxide, or combinations thereof. Such non-fuel components can be for purposes such as premixing the fuel with the oxidant, or atomizing liquid fuels. A fuel can include gaseous fuels, liquid fuels, solids, such as powdered carbon, solid or liquefied polymers or particulate material, slurries, or combinations thereof. Fuel in some cases can include natural gas, liquefied natural gas, landfill gas, atomized oil or mixtures thereof.

The term “landfill” as used herein, refers to a site for disposal of anthropogenic waste materials, and may include surface build-up burial or other physical containment of waste wherein decomposition reactions may occur to generate a hydrocarbon-containing gas. Landfills may be engineered to include layers, containment and caps of various types.

The term “landfill gas” (or LFG), as used herein, refers to one or more gases emanating from a landfill. Landfill gas in some cases includes one or more gases created by the action of microorganisms, typically anaerobic, on organic matter within a landfill, and which may be collectable in a collection system.

The term “oxidant,” as used herein, means a compound or a mixture of compounds capable of delivering oxygen atoms to a substrate. An oxidant may be heated or unheated atmospheric air. In an embodiment, an oxidant can include gas with an enriched oxygen (O₂) molar concentration. Such oxidants include oxygen-enriched air containing at least 25% by volume oxygen, such as “industrially” pure oxygen (e.g., 99.5% oxygen by volume) produced by a cryogenic air separation plant, or enriched oxygen containing gas produced by an adsorption process or membrane permeation process (e.g., at least about 90% oxygen by volume).

The term “cullet,” as used herein, refers to waste and/or recyclable (or reusable) glass, such scraps of unbroken, broken or waste glass often found in municipal solid wastes. A cullet is described in U.S. Pat. Nos. 6,857,999 and 7,565,819, both to Jeanvoine et al. Cullet can be glass sourced from mixed post-consumer streams that include waste and recyclable glass. It may be unwashed or washed, sorted or unsorted. Cullet may include finer size material sorted from a larger cullet aggregate stream, such as for example where cullet fines of less than a selective size are screened and diverted due to operation of color sorting or other process equipment.

The term “high temperature viscosity” (or HTV), as used herein, refers to the temperature at which a substance (e.g., fluid) has a viscosity of 1000 poise.

The term “liquidus,” as used herein, refers to the upper temperature limit for crystallization to occur in a fluid, such as a glass melt.

The term “global warming potential,” (or “GWP”), as used herein, refers to radiative forcing propensity of a gas. GWP as used herein is as defined by the Intergovernmental Panel on Climate Change. Radiative forcing is the change in net irradiance between different layers of the earth atmosphere.

The term “low GWP product,” as used herein, refers to the low net impact on total GWP of gases captured or contained, utilized, consumed and emitted to produce a given quantity of the product. A low GWP glass material can account on a unit of production basis, for the net impact on total GWP of gases captured, contained, utilized and emitted in forming the product, such as a glass material.

### Systems and Methods for Forming Glass Compositions

An aspect of the invention provides a method for forming glass compositions from cullet. A method for forming a glass composition includes providing cullet to a submerged combustion melter (SCM). The cullet is then melted in the SCM to form a molten composition. The cullet is melted with the aid of heat generated by the reaction of a fuel mixture with an oxidant, with the fuel mixture comprising a hydrocarbon (e.g., methane) from landfill gas (LFG). Vitreous fiber is then produced from the molten composition.

In some embodiments, glass compositions are produced with the aid of a system configured to accept cullet and melt the cullet with the aid of heat generated upon the combustion of a fuel, which can include a hydrocarbon from landfill gas, such as methane. The fuel can be supplemented with a polymeric material, such as waste and/or recyclable plastic, as may be provided from a post-consumer source or a landfill. The system can include a submerged combustion melter, which can be a submerged combustion furnace.

The SCM can be in fluid communication with a source of landfill gas from a landfill. In some cases, the SCM can receive landfill gas directly from a landfill via a conduit or pipe in fluid communication with a landfill gas well.

In some cases, the system for producing a glass composition includes a mineral source upstream of the SCM. The mineral source can supply one or more of silica sand, limestone, burnt lime, dolomitic lime, burnt dolomitic lime, soda ash, borax, or other boron-containing material (e.g., colemanite, ulexite) to the SCM. The mineral source may provide controlled amounts of these materials, or other materials, to achieve desired properties of the glass composition. In some embodiments, materials supplied to the SCM may contain silicon, boron, aluminum, alkali metals, alkaline earth metals, or other elements. In some embodiments, such materials contain oxides of silicon, boron, aluminum, alkali metals, alkaline earth metals, and other elements. In other embodiments, such materials contain chloride of silicon, boron, aluminum, alkali metals, alkaline earth metals, or other elements.

The system can include a fiberization unit (also “fiberizer” herein) downstream of the SCM. The fiberization unit accepts molten glass from the SCM and generates glass fibers via fiberization. In some cases, the fiberization is accomplished via rotary fiberization. In other cases, the fiberization is accomplished via cascade fiberization on rotating ceramic or high temperature material wheels, or through other known processes to produce fibers from molten glass primaries by imparting attenuation energy to the cooling molten material.

In some cases, the system includes a conditioning unit between the SCM and the fiberization unit. The conditioning unit can treat, heat, cool or condition molten glass from the SCM prior to fiberization in the fiberization unit, for example to remove entrained gas bubbles or homogenize the molten glass.

In some cases, the SCM is disposed on or adjacent to a landfill. The landfill gas (LFG) from the landfill can then be directly fed to the SCM from a gas well collection system in fluid communication with the SCM. Such a configuration can advantageously reduce, if not eliminate, transportation costs and emission risks due to transporting landfill gas from the landfill to the SCM. In some embodiments, cullet is also sourced from the landfill or nearby or associated recycling facility, which may aid in reducing, if not eliminating, transportations expenses and emissions associated with directing a cullet source to the SCM location.

In some cases, the SCM is disposed directly over a landfill, such as on a foundation, skid platform or other support structure that is in direct contact with landfill. In other cases, the SCM is disposed within about one mile of the landfill, in other cases further if transportation of LFG is feasible.

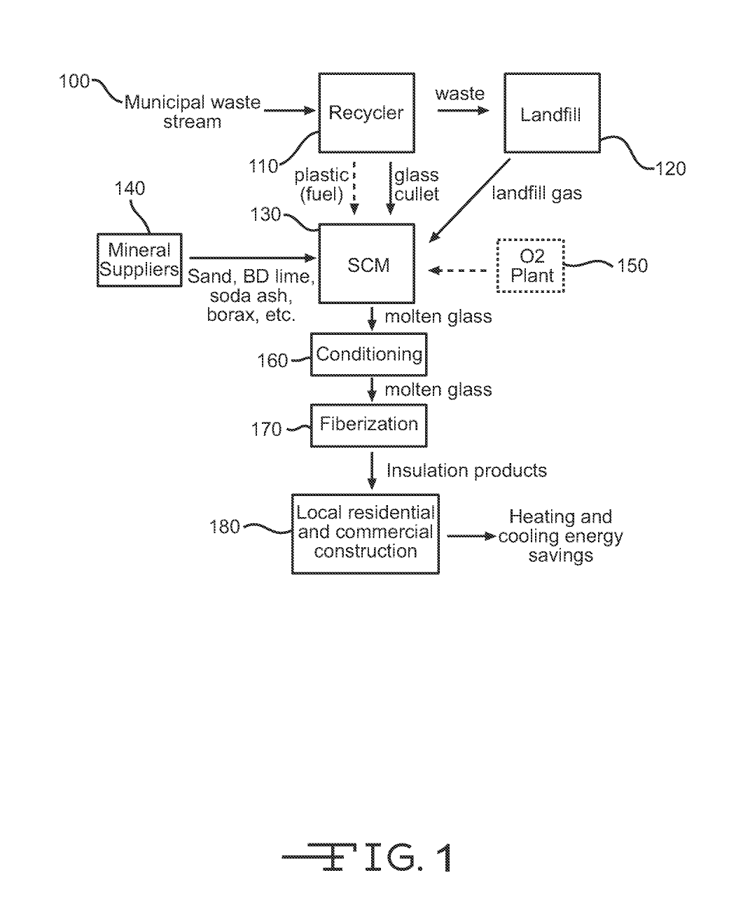

FIG. 1 shows a system for generating glass fiber compositions, in accordance with an embodiment of the invention. The system includes a waste stream (or source) 100, a recycler 110, a landfill 120, a submerged combustion melter 130, a mineral supplier 140, a source of oxygen-containing material 150, a conditioning unit 160, and a fiberization unit 170. The arrows indicated the direction of the flow of material from one unit to another. The recycler 110 can be a source of cullet and/or plastic to the SCM 130.

The SCM 130 can be a submerged combustion furnace (or unit), as described elsewhere herein. The SCM can include a heating chamber for accepting cullet and heating the cullet to generate a melt. The SCM can include an exhaust port for directing vapors that may be generated during combustion of fuel away from the SCM. In some cases, the vapors are directed to one or more emission control units, such as regenerative thermal oxidizers, or scrubbers. The fiberization unit 170 can be a rotary or cascade fiberization unit, as examples.

In some situations, the SCM 130, conditioning unit 160 and fiberization unit 170 are part of an integrated system. In such a case, the conditioning unit 160 can be precluded, or provided between the SCM 130 and the fiberization unit 170. In an example, the conditioning unit 160 includes burners disposed over the flowing molten vitreous mass unit 170, which in an embodiment are supplied with a source of LFG, which may be a lesser heating value form of LFG, as temperatures maintained in the conditioning unit 160 are generally less than required of the SCM 130.

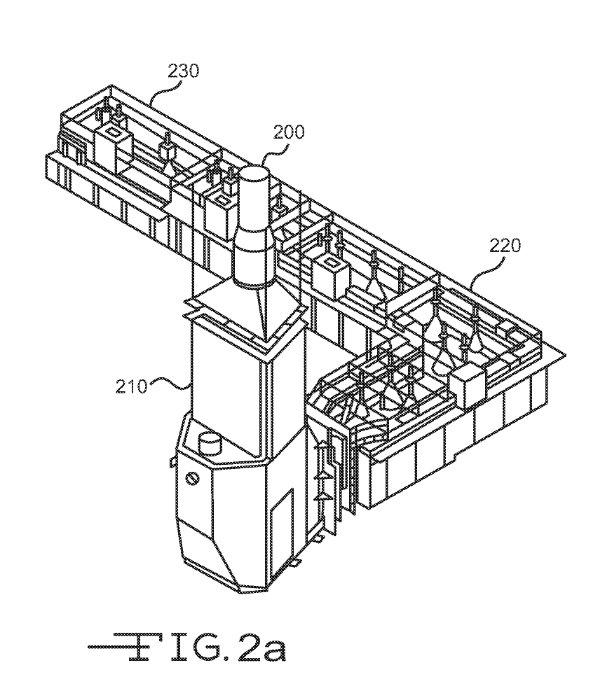

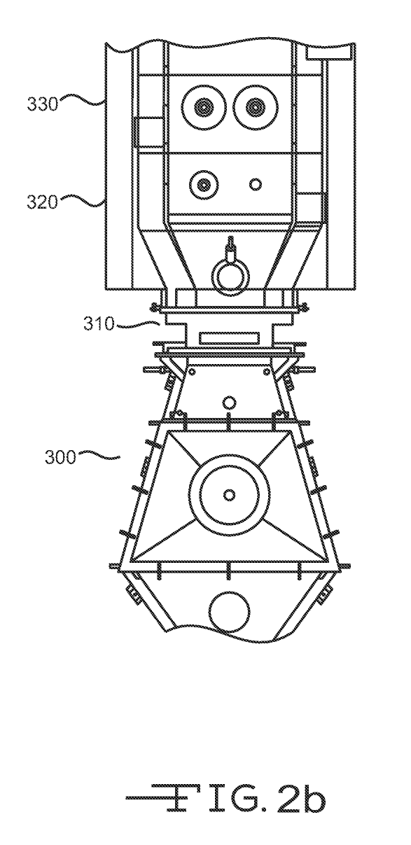

An example of the SCM 130 and conditioning unit 160 is shown in FIG. 2a. Cullet is introduced into the melter 210. Molten glass then flows through the conditioning unit 220. Steps such as foam management and homogenization may occur in the conditioning unit 220. The molten glass then flows into the fiberization unit (not shown), where the molten glass is converted into fibers.

FIG. 2b provides a top-down view of an example of the SCM 130, and conditioning unit 160 of FIG. 1. Molten glass flows from the melter 300 via the water-cooled throat 310 into the conditioning unit 320 and 330.

The cullet can be provided from a mixed post-consumer stream (such as municipal refuse) that includes non-recyclable and recyclable post-consumer waste materials, such as plastic and glass. The recyclable materials comprising cullet can include glass bottles used for consumer products, broken glass from industrial sources, and defective glass discarded by glass producers, as examples. In some embodiments, the LFG or glass or plastic raw materials can be sourced from the same or related entities, such as a waste hauling company or local municipality.

In some cases, LFG includes less than about 45%, or less than about 60%, or less than about 75%, by volume hydrocarbon, such as methane. The landfill gas can be extracted from a landfill where anaerobic digestion produced the landfill gas from waste, such as post-consumer waste. In some embodiments, at least a portion of the balance of landfill gas can be a carbon and oxygen-containing material, such as CO₂. In some cases, the landfill gas also comprises at least about 25%, or at least about 40%, or at least about 75%, by volume carbon dioxide.

In some cases, the fuel mixture further includes a polymeric material. The polymeric material can be sourced from recycled or post-consumer plastic, such as plastic that can be found in mixed post-consumer stream. Examples of the sources of post-consumer plastic are discarded plastic milk jugs, water containers and grocery bags. In some cases, the plastic can include polyethyelene terephthalate (PET), high-density polyethylene (HDPE), low-density polyethylene (LDPE), polypropylene (PP), or polystyrene (PS), which may be delivered to the SCM in solid or molten liquid form.

Fuel compositions include LFG and, in some cases, a polymeric material, may be combusted under the liquid level in the SCM with the aid of an oxidant. In some cases, the oxidant includes at least about 40%, or at least about 45%, or at least about 50%, or at least about 55%, or at least about 60%, or at least about 65%, or at least about 75%, or at least about 80%, or at least about 85%, or at least about 90%, or at least about 95%, or at least about 96%, or at least about 97%, or at least about 98%, or at least about 99%, or at least about 99.5% by volume an oxidizing species, such as oxygen (O₂). The oxygen may be produced in an air separation unit, comprising for example cryogenic distillation, adsorption or membrane separation processes.

An exemplary process for forming glass compositions with the aid of systems provided herein includes directing cullet to an SCM and heating the cullet with the aid of heat generated from the combustion of landfill gas to produce a molten composition. The molten composition in some cases includes a major proportion of SiO₂. The molten composition can be directed to a fiberization unit downstream of the SCM. The fiberization unit can be a rotary fiberization unit or a cascade fiberization unit. The molten composition can be directed to the fiberization unit via for example a weir to a channel or pipe, or by opening a valve or fluid-control device under the liquid level of the container where the molten composition is formed.

In some cases, one or more materials, such as silica sand, limestone, burnt lime, dolomitic lime, burnt dolomitic lime, soda ash, borax, colemanite, or ulexite, can be added to the cullet to form a vitrifiable batch. The source of materials to be added to the cullet can be placed upstream of the SCM, providing controlled amounts of such materials to achieve desired properties of the vitreous fiber. In some embodiments, such materials may contain silicon, boron, aluminum, alkali metals, alkaline earth metals, or other elements. In some embodiments, such materials contain oxides of silicon, boron, aluminum, alkali metals, alkaline earth metals, and other elements. In other embodiments, such materials contain halide of silicon, boron, aluminum, alkali metals, alkaline earth metals, or other elements, where the halide can be defined as a fluoride, chloride, bromide, or iodide.

With reference to FIG. 1, in an exemplary process for forming glass compositions, glass, plastic, and/or waste from the municipal waste stream 100 are provided and portions sorted at the recycler 110 into recyclable materials and non-recyclable waste. The waste is directed to the landfill 120. Over time, waste in a landfill decomposes into various products, such as landfill gas (LFG). Typically, landfill gas is formed in a landfill through the action of microorganisms present or placed in the landfill. Recyclable materials, such as glass and plastic in a post-consumer stream can be diverted from the landfill by a recycler. The glass and plastic may be treated after diversion for uses and improved handling by mechanical means, including crushing, shredding or the like, and organic and other matter may be washed fully or partially therefrom by known means, to form among other things washed glass cullet. Glass cullet useful in the present invention may be washed, partially or fully, or delivered to the SCM without washing, in whole or crushed form, and may have been separated from aggregate cullet.

Cullet is melted in the SCM 130 with the aid of heat generated upon the combustion fuel with the aid of an oxidant. The fuel comprises landfill gas (LFG) and, in some cases, a polymeric material, such as recycled and/or waste plastic. The oxidant can include a gas mixture comprising an oxidizing agent, such as oxygen gas. In the SCM the cullet is brought in contact with the fuel and the oxidant.

At the SCM 130, the glass is melted by the process of submerged combustion melting. One or more minerals from the mineral suppliers 140 may be introduced to the SCM 130 to enable the formation of a vitreous fiber of desirable or otherwise predetermined properties. An oxidant or oxygen-enriched gas is introduced from O₂ source 150. The molten glass is then directed to the conditioning unit 160 and subsequently the fiberization unit 170 to create vitreous fibers, which may be formed upon attenuation and cooling. These fibers can be used as insulation materials in residential and/or commercial settings 180, such as in wall insulation, attic insulation, or thermal or acoustical insulation for any purpose or other structural components, or further processed or combined with other materials and/or components to make composites or other useful products.

In some embodiments, molten glass generated in the SCM 130 is conditioned in the conditioning unit 160 prior to fiberization. In some cases, molten glass is conditioned according to the methods set forth in U.S. patent application Ser. No. 13/268,130, filed Oct. 7, 2011, which is entirely incorporated herein by reference. The conditioning unit 160 in some cases can be reduced or even precluded, in which case molten glass is directed from the SCM 130 to the fiberization system 170.

In some cases, vitreous fibers formed per the process of FIG. 1 can provide various benefits, such as energy savings when placed in use. Insulation or other products having fibrous components formed according to the process of FIG. 1 can have low Product GWP. In some situations, the formation of products having fibrous components formed according to the process of FIG. 1 can advantageously reduce overall greenhouse gas emissions, and low or negative net GWP which can have a direct beneficial effect and aid in the lessening or forestalling of global warming.

In some embodiments, the SCM 130 operates by submerged combustion melting, which can involve melting glass batch materials to produce molten glass by fuels that react with oxygen, oxygen-air mixtures, or air along with a liquid, gaseous fuel, or particulate fuel in the glass batch, directly into a molten pool of glass, usually through burners submerged in a glass melt pool. Devices suitable for submerged combustion melting are described in, for example, U.S. patent application Ser. No. 12/817,754 to Huber, U.S. patent application Ser. No. 12/888,970 to Charbonneau et al., and U.S. Pat. No. 7,273,583 to Rue et al., which are entirely incorporated herein by reference. In an SCM, the direct contact of oxidant and fuel with the glass batch causes the glass batch material to melt.

Submerged combustion melters (SCMs) that may be useful in methods and systems provided herein can be formed of metal, ceramic, ceramic-lined metal, or combination thereof. Suitable metals include stainless steels, such as, for example, Grade 306 and Grade 316 steel, as well as titanium alloys, aluminum alloys, and the like. U.S. patent application Ser. No. 13/268,065 describes operation of SCMs and materials that may be used to manufacture them. Combustion heating apparatuses are also generally described in U.S. Pat. No. 4,059,386 to Eising, and submerged combustion processes for melting glass are specifically described in U.S. Pat. No. 4,539,034 to Hanneken et al. and U.S. patent application Ser. No. 12/817,754. Other patents and patent applications describing SCM's, particularly submerged combustion processes for application in commercial glass melting include, U.S. Pat. Nos. 4,539,034; 3,170,781; 3,237,929; 3,260,587; 3,606,825; 3,627,504; 3,738,792; 3,764,287; 6,460,376; 6,739,152; 6,857,999; 6,883,349; 7,273,583; 7,428,827; 7,448,231; 7,565,819, and 7,624,595; U.S. Patent Publication Nos. 2004/0168474, 2004/0224833, 2007/0212546, 2006/0000239, 2002/0162358, 2009/0042709, 2008/0256981, 2007/0122332, 2004/0168474, 2004/0224833, 2007/0212546, and 2010/0064732; and PCT Patent Publication No. WO/2009/091558. As another example, U.S. Pat. No. 4,397,692 to Ramge et al. describes combustion apparatus specifically adapted to process cullet.

FIG. 2a schematically illustrates a submerged combustion melter (SCM), along with a glass conditioning unit, in accordance with an embodiment of the invention. FIG. 2b schematically illustrates a top-down view of an SCM, along with entrance to a glass conditioning unit. Design and operation of an SCM with desired features are given in, for example, U.S. patent application Ser. Nos. 13/268,098, 12/817,754, and 13/268,130. SCMs that can be used to process recycled glass are described in U.S. patent application Ser. No. 12/888,970. The process improvements in SCMs described in these related applications enable various refinements of the submerged combustion melting process, including improved control of foaming of molten glass, reduction of exhaust pressure and exhaust volume fluctuations, among other improved apparatus and methods.

In some embodiments, once the glass is melted in the SCM, the molten glass is directed to a fiberization system. In an example, with reference to FIG. 1, the SCM 130 discharges a stream of molten glass, in some cases free of landfill gas and plastic residues, to a conditioning unit 160 and subsequently a fiberization zone, which may be in the fiberization unit 170. U.S. patent application Ser. No. 12/817,754 describes a method for discharging or draining molten glass into a fiberization zone in the SCM's, where the design of the apparatus enables the submerged combustion melting process to overcome various problems, such as clogging.

The process and associated systems of FIG. 1 enable cullet to be melted in an SCM using heat generated upon the reaction of a fuel with an oxidant. The fuel can be landfill gas extracted from a landfill. The molten glass can be further conditioned and formed into vitreous fibers by techniques such as rotary fiberization or cascade fiberization. In some embodiments, a rotary fiberizer or cascade fiberizer, in a fiberization zone, is located downstream of the SCM, such that the molten glass flows to the fiberization zone. Fiberization then takes place according to methods known in the art. Methods and systems for fiberization, such as cascade and rotary fiberization, are described in, for example, U.S. Pat. Nos. 8,104,311 to Baker et al., 6,245,282 to Baker et al., 5,954,852 to Jensen et al., 5,131,935 to Debouzie et al., 4,756,732 to Barthe et al., 4,203,774 to Battigelli et al., 3,260,857 to DoIf et al., and 2,609,566 to Slayter et al., which are entirely incorporated herein by reference.

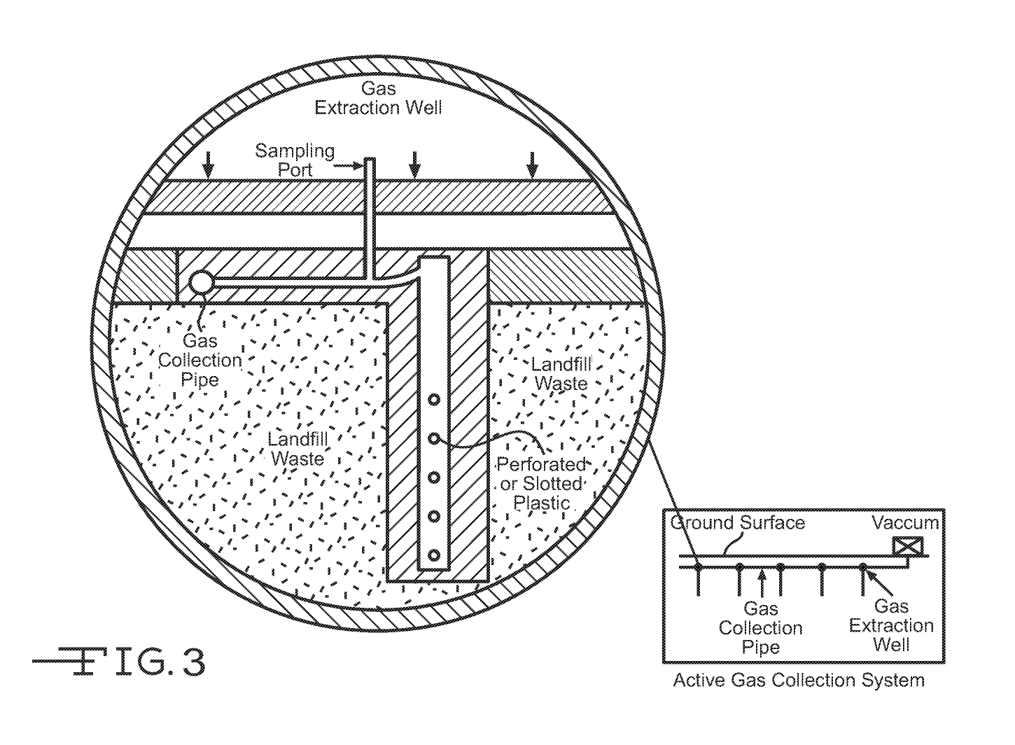

With reference to FIG. 3, landfill gas can be sampled and collected from a landfill via a gas extraction unit. In some embodiments, an SCM may be placed adjacent to a landfill and in fluid communication with a source of LFG via a pipe or the like. The gas extraction unit can include a fluid flow path in communication with the landfill gas source. The fluid flow path can include a pipe or other tubing formed of a perforated or slotted polymeric material, such as plastic. The fluid flow path can extend into landfill mass, such as along a direction orthogonal to ground, as shown. Such adjacent location configuration can render extended transport of LFG unnecessary, providing further savings in energy and transportation costs. In some embodiments, the SCM may be in fluid communication with a source of landfill gas from a landfill, such as a source depicted in FIG. 3. LFG can be sampled and collected from landfills via a gas extraction unit schematically shown in FIG. 3.

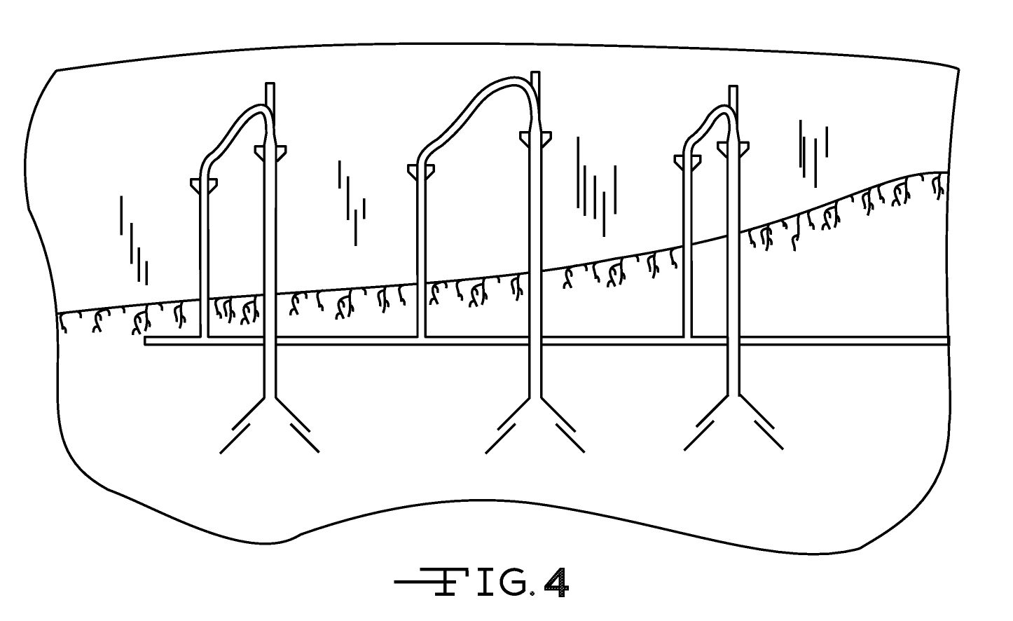

FIG. 4 shows a fluid flow system comprising piping, which can be used to collect LFG from a landfill. The piping may be extended to an SCM and optionally equipped with a scrubber or other known process to remove undesirable constituents from LFG. LFG can then be combusted in an SCM as fuel and with oxidants as provided herein.

In some cases, compared to conventional flares used to burn off LFG, submerged oxy-burners fed with fuels of the present invention can generate significantly higher temperatures—e.g., greater than 600° C. with oxy-burners as opposed to 350-400° C. with flares. The high temperature not only has the effect of ensuring combustion of methane in LFG, but also of combusting other materials such as siloxane in LFG that may not be fully decomposed in a flare and escape to the atmosphere. Moreover, in some cases the residence time of LFG in oxy-burners may be greater than that in flares, ensuring more complete combustion. In some cases, constituents or products of decomposition of LFG components, such as silica-containing compounds or siloxane, are incorporated directly into the vitreous molten mass.

In some embodiments, an SCM is installed on a landfill. A fluid flow path, such as a pipe, is then brought in fluid communication with landfill gas by driving a fluid flow path configured to extract landfill gas into a mass of landfill (see FIG. 3). Landfill gas is then directed to the SCM or conditioning unit and used to generate heat by combusting a hydrocarbon (e.g., methane) and, in some cases, a polymeric material, in the presence of an oxidant. The polymeric material can be plastic diverted from a landfill, and the oxidant can be O₂. Cullet from glass diverted from a landfill (or other source of cullet) is then directed to the SCM, where it is melted to a melted composition that is directed to a fiberizer to form a glass composition, such as vitreous fiber.

### Fuel Mixtures and Oxidants

Another aspect of the invention provides fuel mixtures comprising methane sourced or provided from a landfill and optionally a polymeric material sourced from recycled or post-consumer plastic. The fuel mixture can be used for various purposes, such as melting glass cullet. In some cases, the fuel mixture is capable of melting cullet upon reaction with an oxidant (i.e., combustion). In an example, the reaction between the fuel mixture and the oxidant generates heat, which can be used to melt glass materials that are comprised in cullet, such as, for example, glass bottles used to hold consumer products, broken glass from industrial sources, and defective glass discarded by glass producers.

In some cases, the cullet material is provided from a mixed post-consumer stream, such as a waste stream that comprises both waste and recyclable products. Material for cullet can be separated from waste by a recycler. In the present invention, post-consumer polymeric material can be separated and used to supplement LFG as fuel. The recycled or post-consumer polymeric material can be a component of post-consumer materials, such as discarded plastic milk jugs and grocery bags. The polymeric material can include one or more of polyethyelene terephthalate (PET), high-density polyethylene (HDPE), low-density polyethylene (LDPE), polypropylene (PP), or polystyrene (PS).

In some embodiments, the oxidant comprises a gas mixture comprising at least about 40%, or at least about 45%, or at least about 50%, or at least about 55%, or at least about 60%, or at least about 65%, or at least about 75%, or at least about 80%, or at least about 85%, or at least about 90%, or at least about 95%, or at least about 96%, or at least about 97%, or at least about 98%, or at least about 99%, or at least about 99.5% by volume oxidizing agent, such as oxygen (O₂). In some embodiments, gas mixtures comprising oxygen gas at high concentrations, such as oxygen gas of at least about 90% by volume, are produced in an air separation unit (herein also “cryogenic air separation plant”), by an adsorption process or membrane permeation process. In some embodiments, oxidant mixtures containing a high concentration of oxygen gas, such as at least about 90% of oxygen gas by volume, are used to combust the fuels in a burner designed for high-oxygen mixtures. Such burners, sometimes called “oxy-burners,” are described in U.S. patent application Ser. No. 13/268,028, and can be used with the SCMs of the present invention.

A component of the fuel mixture is landfill gas (LFG). Landfill gas can form over time from post-consumer waste that is deposited in a landfill. Over time, the waste undergoes anaerobic digestion, forming a gas mixture that comprises a hydrocarbon, in some cases primarily methane. In some cases, landfill gas can also include carbon dioxide. In some embodiments, LFG comprises at least about 25%, 30%, 35%, 40%, 45%, 50%, 55%, 60%, 65%, or 75% by volume carbon dioxide. In some cases, LFG comprises less than about 75%, 60%, 50%, 40%, 35%, or 30% by volume hydrocarbon, such as methane. In some embodiments, methane can be sourced from LFG.

The methane content of LFG makes it a potent greenhouse gas once LFG escapes landfills. The higher impact of methane relative to carbon dioxide upon climate stability and to its role in building up anthropogenic tropospheric ozone has been recognized. See, e.g., Shindell et al., “Simultaneously Mitigating Near Term Climate Change and Improving Human Health and Food Security,” Science, Vol. 355, pp. 183-188 (Jan. 13, 2012).

Conversion of methane in LFG, via combustion, to carbon dioxide, while at the same time taking advantage of its potential as a fuel, provides significant climate and thus global economic benefits, such as through the reduction of greenhouse gas and crop-damaging tropospheric ozone, in addition to energy conservation benefits, such as through heat energy generated in the combustion process as described herein.

Because of its high carbon dioxide content, LFG is not readily salable to a public utility and cannot be readily utilized in a public utility pipeline as a fuel. However, LFG can be used in an SCM, such as in a submerged combustion melting process. It may be supplemented with a polymeric material, such as plastic, as an additional fuel component, and with an appropriate oxidant.

### Glass Compositions

Another aspect of the invention provides glass compositions, which may be fibrous glass compositions. Such glass compositions can be formed using processes described elsewhere herein.

Glass compositions provided herein may be used to form wall or attic insulation or other structural components, as may be used in residential, commercial and/or industrial settings. In some situations, glass compositions can be used to form composites. In other situations, glass compositions can be used to form panels and duct boards.

Glass compositions provided herein can have properties suitable for various uses and applications. In some embodiments, a glass composition, as may be formed via processes disclosed herein (e.g., the process of FIG. 1), has a biosolubility (or biodissolution rate constant, or k_{dis}) of at least about 50 nanograms (“ng”)/cm²/hr, 100 ng/cm²/hr, 150 ng/cm²/hr, 200 ng/cm²/hr, 300 ng/cm²/hr, 400 ng/cm²/hr, 500 ng/cm²/hr. In some cases, a glass composition comprising vitreous fiber can have a dissolution rate constant in simulated lung fluid (k_{dis}) of at least about 50 ng/cm²/hr, 100 ng/cm²/hr, 150 ng/cm²/hr, 200 ng/cm²/hr, 300 ng/cm²/hr, 400 ng/cm²/hr, or 500 ng/cm²/hr.

Typically, a high-temperature viscosity (HTV) value of the material is greater than the liquidus temperature of the material. The glass composition of the present invention can have an HTV value of at most about 2230° F., 2130° F., 1930° F., or 1830° F. In some cases, a difference between the HTV value and the liquidus temperature of the material is at least about 1° F., 10° F., 50° F., 100° F., 200° F., 300° F., 400° F., or 500° F. In an example, a glass composition has an HTV value of at most about 2150° F., or at most about 2100° F., or at most about 2050° F., and a liquidus temperature of at most about 2050° F., or at most about 2000° F., or at most about 1950° F. The HTV value and liquidus temperature can be selectively altered to effect glass compositions properties as may be desired or otherwise predetermined, such as to adapt to selected batch materials or process technology.

A glass composition can have a moisture resistance (G_{hyd}) greater than or equal to about −10 kcal/mol, −9 kcal/mol, −8 kcal/mol, −7 kcal/mol, −6 kcal/mol, or −5 kcal/mol. The glass composition can be produced from a vitrifiable batch comprising greater than about 80% post-consumer cullet having a SiO₂ content of at least about 64% by weight.

In an example, a glass composition has the biosolubility of at least about 200 ng/cm²/hr, and a difference in liquidus temperature and HTV value of at least about 100° F. In some embodiments, the biosolubility of the material is at least about 140 ng/cm²/hr, 180 ng/cm²/hr, 220 ng/cm²/hr, 260 ng/cm²/hr, or 300 ng/cm²/hr.

In some embodiments, the difference between the liquidus temperature and the HTV value of a glass composition is at least about 190° F., 210° F., 230° F., or 250° F. In some embodiments, G_{hyd} is greater than at least about −10 kcal/mole, or −9 kcal/mole, or −8 kcal/mole, or −7 kcal/mole, or −6 kcal/mole, or −5 kcal/mole.

Glass compositions provided herein can be fibrous—and collected following fiberization by known means, and process to shaped fibrous insulation or processed in for instance a hammer mill to produce loose-fill or blowing wool products, and may include a cured binder in some cases. In some embodiments, the present process produces fiber having an average fiber diameter of between about 1 and about 20 micron. Fiber diameter sizes can vary based on process parameters, such as heating and/or cooling rate or the glass melt used to form the glass composition, or the fiberization process employed.

In some embodiments, at least about 75%, 80%, 90%, or 99% of the glass composition by weight is sourced (or provided from) from cullet. The cullet can be sourced from post-consumer or recycled glass, such as glass from a municipal waste stream.

In some cases, the cullet has no more than about 0.1%, 0.2%, 0.3%, 0.4%, 0.5%, 1.1%, 1.3%, 1.5%, 1.7%, or 1.9%, or 2.1%, or 2.3%, or 2.5% B₂O₃ by weight.

In some embodiments, the vitrifiable composition comprises a lime-containing material. The lime-containing material can include one or more of limestone, quicklime, dolomitic lime, and burnt dolomitic lime. In some cases, the vitrifiable batch composition comprises one or more of silica sand, soda ash, borax, colemanite and ulexite.

Properties of glass compositions, such as vitreous fibers, formed with the aid of methods, systems, and fuels provided herein can be adjusted with mineral additives, in FIG. 1 herein also “Mineral Suppliers.” Exemplary properties include HTV, liquidus, k_{dis} and G_{hyd}. Exemplary parameters and their significance are described in U.S. Pat. No. 7,763,558 to Bauer et al.

Table 1 shows the elemental composition and properties of an exemplary cullet sample, as may be used with processes provided herein (e.g., the process of FIG. 1).

TABLE 1
Exemplary cullet composition and properties

| Oxide | Weight t % |
|---|---|
| SiO₂ | 72.4 |
| Al₂O₃ | 1.5 |
| B₂O₃ | <0.1 |
| R₂O (e.g., Na₂O + K₂O) | 13.9 |
| XO (e.g., CaO + MgO) | 11.5 |
| Other | <1.0 |
| Property | Predicted Value |
| HTV (F.) | 2156 |
| Liquidus (F.) | 1761 |
| k_{dis} (ng/cm²/hr) | 75 |
| ΔG_{hyd} (kcal/mol) | −5.6 |

Some challenge was presented with using recycled cullet in high proportion or as essentially the only raw material for making glass fiber, and the associated higher HTV and the relatively lower biodissolution rate was one issue solved. In some cases, lower HTV is more appropriate for fiberization, especially for rotary fiberization. A high biodissolution rate may be preferable from a fiber health standpoint. In an embodiment, an upper limit for HTV is about 2130° F., or about 2030° F. In an embodiment, a lower limit for biodissolution rate (or k_{dis} in some cases) is 100 ng/cm²/hr, or about 150 ng/cm²/hr. Consideration can be given for liquidus and ΔG_{hyd} when modifying the chemistry of the glass composition. The liquidus in some cases can be minimized to a value below about 2050° F., or below about 1950° F. for ease of fiberization. Lower liquidus values can be desirable for rotary fiberization to avoid devitrification in the fiberization process, which can lead to plugging of spinner disc holes.

The free energy of hydration is a measure of hydrolytic resistance of glass fiber (herein also “vitreous fiber”) in the glass composition produced according to methods provided herein. It may be preferable to have the values of ΔG_{hyd} greater (i.e., more positive) than about −8.0 kcal/mol, or greater than about −7.0 kcal/mol. This may aid in prolonging product lifetime such that, in some cases, the product does not appreciably degrade over time, such as in humid conditions. U.S. Pat. No. 5,401,693 to Bauer et al. explains how varying the composition of vitreous fiber can improve biosolubility without significantly affecting hydrolytic resistance of the final vitreous fiber product.

In some embodiments, glass compositions include silica sand, limestone, quicklime, dolomitic lime, burnt dolomitic lime, soda ash, borax (i.e., B₂O₃), or other boron-containing material (such as, e.g., colemanite or ulexite). Such materials can aid in decreasing HTV and increasing biosolubility or K_{dis}. These mineral additives enable the formation of a vitrifiable batch with a desirable or otherwise predetermined HTV value, which can be further converted to vitreous fiber with a desirable or otherwise predetermined biosolubility value.

Glass compositions provided herein can include other additives. An additive in glass making is alkali metal oxide (R₂O), where ‘R’ can include an alkali metal such as Li, Na, or K. In some cases, increasing R₂O content while decreasing SiO₂ content can result in a decrease in HTV value, an increase in biosolubility, and a decrease in liquidus, which in some cases can be advantageous property changes. In some situations, a potential drawback of an alkali increase is a decrease in moisture resistance, ΔG_{hyd}. Increasing the alkaline earth content while decreasing SiO₂ can be used to decrease HTV and increase biosolubility, but can also have a negative impact on both moisture resistance and liquidus. In some situations, it is desirable to increase biosolubility, and significant increases in the Al₂O₃ above the level found in recycled glass cullet are not desirable. In some cases, an alkaline earth metal oxide (XO), where ‘X’ is can include alkaline earth metal such as Mg, Ca, Sr, and Ba, is added to glass.

In some embodiments, increasing B₂O₃ can improve the balance of biosolubility, HTV, liquidus and ΔG_{hyd}, but can be undesirable from a cost and sustainability standpoint because of processing and transportation impacts. In some cases, however, a small amount (up to about 3% B₂O₃) can be justified as a means to enable the process of the present invention and achieve an overall improvement in cost, recycling, and environmental impact. In some embodiments, about 0.5%, or about 0.7%, or about 0.9%, or about 1.1%, or about 1.3%, or about 1.5%, or about 1.7%, or about 1.9%, or about 2.1%, or about 2.3%, or about 2.5%, or about 2.6%, or about 2.7%, or about 2.8%, or about 2.9%, or about 3.0% B₂O₃ by weight can be added to the batch comprising a major proportion of cullet.

TABLE 2
Exemplary glass compositions

| | | A | B | C | D | E | F | G | H |
|---|---|---|---|---|---|---|---|---|---|
| Glass | SiO₂ | 71.20 | 69.74 | 66.09 | 66.94 | 66.35 | 70.64 | 68.75 | 68.63 |
| Composition | Al₂O₃ | 1.35 | 1.35 | 1.35 | 1.35 | 1.34 | 1.50 | 1.50 | 1.49 |
| (weight %) | B₂O₃ | 0.00 | 0.00 | 0.00 | 2.00 | 2.00 | 0.00 | 0.00 | 2.49 |
| | Na₂O | 13.33 | 11.39 | 14.74 | 13.07 | 16.39 | 13.01 | 13.42 | 15.51 |
| | K₂O | 0.45 | 0.45 | 0.45 | 0.45 | 0.45 | 0.50 | 0.50 | 0.50 |
| | CaO | 11.03 | 12.99 | 13.16 | 12.49 | 10.92 | 11.80 | 12.65 | 10.09 |
| | MgO | 2.25 | 3.69 | 3.81 | 3.32 | 2.16 | 2.12 | 2.75 | 0.86 |
| | R₂O | 13.78 | 11.84 | 15.19 | 13.52 | 16.84 | 13.52 | 13.92 | 16.01 |
| | XO | 13.28 | 16.68 | 16.98 | 15.81 | 13.08 | 13.92 | 15.40 | 10.95 |
| | Other | <1.0 | <1.0 | <1.0 | <1.0 | <1.0 | <1.0 | <1.0 | <1.0 |
| Predicted | HTV (F) | 2128 | 2128 | 2017 | 2027 | 1970 | 2123 | 2083 | 2017 |
| Properties | Liquidus | 1856 | 2023 | 2005 | 1960 | 1783 | 1897 | 1958 | 1663 |
| | (F) | | | | | | | | |
| | Delta T (F) | 272 | 105 | 13 | 67 | 187 | 227 | 126 | 354 |
| | K_{dis} | 110 | 150 | 250 | 250 | 250 | 110 | 150 | 160 |
| | (ng/cm²/hr) | | | | | | | | |
| | ΔG_{hyd} | −6.22 | −6.53 | −7.87 | −7.04 | −7.46 | −6.27 | −6.88 | −6.47 |
| | (kcal/mol) | | | | | | | | |
| Raw | sand | 9.79 | 8.32 | 4.66 | 5.51 | 4.92 | 2.01 | 0.10 | |
| Materials | borax | | | | 4.11 | 4.11 | | | 5.13 |
| (lbs per | soda ash | 3.57 | 0.22 | 6.01 | 1.59 | 7.34 | 0.74 | 1.45 | 3.15 |
| 100 lbs of | BD lime | 3.47 | 6.88 | 7.17 | 6.01 | 3.27 | 2.97 | 4.46 | 0.00 |
| glass) | cullet | 85.00 | 85.00 | 85.00 | 85.00 | 85.00 | 95.00 | 95.00 | 95.00 |
| | Total | 101.84 | 100.41 | 102.84 | 102.22 | 104.64 | 100.72 | 101.01 | 103.27 |

From Table 2, it can be seen that the various trade-offs between the four key properties can be tailored to the specific needs of the process and product application. The raw material costs of the glass formulas listed in Table 2 can be approximately 30-70% less than the raw material costs of typical insulation fiberglass formulations. The examples provided in Table 2 can use burnt dolomitic (BD) lime as a raw material source but this can easily be substituted with other forms of lime and limestone materials. In some cases, borax (B₂O₃) can be advantageously substituted by other boron-containing raw materials.

The examples listed in Table 2 may be suitable for both rotary (internal centrifuge) fiberization and the cascade (external centrifuge) mineral wool fiberization, with the possible exception of Example C not being generally suitable for rotary fiberization because of the low temperature difference (delta T) between HTV and liquidus.

The balances and compromises between the various property needs of molten glass and vitreous fiber can be achieved within the composition range shown in Table 3, using the set of raw materials shown in Table 4. There are various potential compositions within the ranges set out in the Tables 3 and 4, which are applicable to compositions and processes provided herein.

TABLE 3
Exemplary composition ranges

| | Weight % |
|---|---|
| SiO₂ | 63 to 73 |
| Al₂O₃ | 1.0 to 1.8 |
| B₂O₃ | 0.0 to 3.0 |
| R₂O | 10 to 18 |
| XO | 9 to 18 |
| Other | <1.0 |

TABLE 4
Exemplary raw material ranges

| | lbs per 100 lbs |
|---|---|
| Component | of glass |
| recycled glass cullet | 80 to 97 |
| silica sand, limestone, burnt lime (quicklime), | 0 to 10 |
| dolomitic lime, burnt dolomitic lime, soda | |
| ash, borax, colemanite, ulexite | |

### Low Global Warming Potential Materials and Products

Another aspect of the invention provides low global warming potential (GWP) materials, which can include glass compositions provided herein. Low GWP glass materials can be formed via a process that significantly reduces net GHG impact to produce such materials, in addition to reducing emissions, such as emissions associated with transporting materials used to form the materials, and transporting the product produced from the materials.

In some embodiments, the fuel used to form a glass composition comprises landfill gas and, in some cases, a polymeric material. Landfill gas is considered a renewable form of energy and moreover when collected and combusted in an SCM as described herein has a positive environmental impact due to conversion of methane (a potent greenhouse gas) into carbon dioxide, a gas that is far less potent than methane as a greenhouse gas, such as, for example, about 21 times less potent). Even some or partial destruction of methane in landfill gas can generate environmental benefits, as described, for example, in U.S. Pat. No. 7,959,376 to Duesel et al. In some embodiments of the present invention, methane in LFG is converted to CO₂. The energy release in the process is used to produce glass compositions, such as usable vitreous fibers, from cullet. The glass compositions can be used to form other materials with desirable properties, such as energy saving thermal insulation.

Processes provided herein, such as the process of FIG. 1, enable the formation of low GWP material, in which the overall GWP impact of forming the material is reduced in relation to other available formation processes, and the processes provided herein decrease the total environmental impact of fugitive methane.

In some cases, at least about 25 equivalents, or at least about 35 equivalents, or at least about 45 equivalents, or at least about 50 equivalents, or at least about 65 equivalents, or at least about 75 equivalents of carbon dioxide are destroyed per pound of glass material formed by the processes disclosed herein. The formation of the low GWP glass material thus exhibits a net negative GWP, the established measurement of a greenhouse gas impact on the environment.

In some embodiments, every mole of LFG methane that is combusted reduces GWP by a factor of at least about 20, since the greenhouse gas potential of methane is significantly greater than that of carbon dioxide. Methane may be considered a potent greenhouse gas that is a key contributor to global climate change. Methane is a powerful greenhouse gas that acts like a catalyst to produce ozone in the lower atmosphere, negatively impacting crops and mammalian health. Methane also has a short atmospheric life relative to carbon dioxide and other greenhouse gases. Because methane is both potent and short-lived, reducing methane emissions from landfills may aid in achieving a near-term beneficial impact in mitigating global warming.

Additional greenhouse gas reductions and energy savings can be achieved through the insulation materials made from the glasses, such as vitreous fibers, prepared according to some embodiments of the invention. In some cases, upgrading or retrofitting glass fiber insulation, such as mineral wool insulation in residential and/or commercial buildings, with glass compositions provided herein can improve the thermal efficiency and thereby decrease the annual emission of carbon dioxide from building HVAC systems, or the electric power utility plants supplying them.

In some embodiments, greenhouse gas emission credits are obtained for destroying carbon dioxide equivalents. After carbon dioxide equivalents are destroyed in the course of landfill methane collection and combustion, an application can be made for carbon credits based on reduction of greenhouse gas potential resulting therefrom.

In some embodiments, greenhouse gas emissions are tradable on a financial exchange. The principles of applying for greenhouse gas emission reduction credits and trading them on financial exchanges are described in U.S. Pat. No. 7,959,376 to Duesel et al. In an example, the process of FIG. 1 is used to reduce greenhouse gas emissions in exchange for greenhouse gas emission reduction credits.

### Tropospheric Ozone Inertion

Another aspect of the invention provides a method for inerting an ozone precursor. As used herein, “inerting” means to significantly reduce the GWP of a composition or molecule through reaction or conversion to a form having lesser GWP. The ozone precursor can be an atmospheric ozone precursor, such as a tropospheric ozone precursor. The method comprises collecting an ozone precursor resulting from degradation of post-consumer waste, delivering the ozone precursor to a combustion zone under a molten mass in an SCM (see, e.g., FIG. 1), and reacting the ozone precursor with an oxidizer, thereby liberating heat. The heat is utilized to melt or maintain the molten mass.

In some cases, the ozone precursor comprises a hydrocarbon derived from a landfill, such as methane that may be found in landfill gas. In the combustion zone, the methane is converted to carbon dioxide. Carbon dioxide may not have the deleterious effects of methane in contributing to the formation of tropospheric ozone, and methane is generally considered more harmful to climate stability than carbon dioxide. The role of methane in facilitating the formation of anthropogenic tropospheric ozone is known. See, e.g., Shindell et al., “Simultaneously Mitigating Near Term Climate Change and Improving Human Health and Food Security,” Science, Vol. 355, pp. 183-188 (2012), which is entirely incorporated herein by reference.

The molten mass to which the ozone precursor is delivered can be a vitreous mass at a melt temperature of at least about 1700° F. In some cases, the temperature of the vitreous mass is at least about 2700° F., or at least about 2500° F., or at or at least about 2100° F., or at least about 1800° F.

### Example 1

Cullet from a landfill is directed to a solids melding unit and mixed with a quantity of post-consumer plastic. Boron-containing component is added to the cullet batch, or to the molten mass in the SCM. Landfill gas is piped from a landfill gas well into a burner under the molten mass in the SCM. From a different inlet, an oxidant comprising at least 95% oxygen by volume is delivered to the vicinity of the SCM burner, where it contacts the hydrocarbons and polymers. The plastic and the methane in landfill gas is combusted under these conditions. The energy released during combustion heats the cullet and batch to a temperature of about 2500° F., thereby melting the cullet. A weir near the liquid level of the SCM is reached when sufficient batch material is added and melted in the SCM, thus allowing the molten glass to flow to a cascade fiberization unit via a conditioning channel. The molten glass is thereby drawn out into fibers and thereafter cooled. The resulting fibers are then incorporated into a thermal insulation product.

### Example 2

A process for forming glass compositions requires an energy input of about 2,100 BTU of energy to melt a pound of glass composition produced (e.g., vitreous fiber). This energy can be provided from the combustion of about 2.1 standard cubic feet of methane per pound of glass composition produced. The methane is provided from landfill gas, as described above.

The number of moles of methane consumed in making a pound of glass is approximately 2.5. In some cases, every mole of otherwise fugitive methane collected is equivalent to 21 moles of emitted carbon dioxide in terms of its global warming potential, or GWP. The production of each pound of glass according has the effect of reducing overall GWP by an equivalent of 50 moles of carbon dioxide (2.5 moles of CH₄×20 CO₂ equivalents of greenhouse gas destroyed by collected CH₄ combustion). The formation of glass compositions using energy generated from the combustion of landfill gas can thus result in the destruction of greenhouse gas in the amount of 50 moles of carbon dioxide equivalents per pound of glass material formed.

It should be understood from the foregoing that, while particular implementations have been illustrated and described, various modifications may be made thereto and are contemplated herein. It is also not intended that the invention be limited by the specific examples provided within the specification. While the invention has been described with reference to the aforementioned specification, the descriptions and illustrations of embodiments of the invention herein are not meant to be construed in a limiting sense. Furthermore, it shall be understood that all aspects of the invention are not limited to the specific depictions, configurations or relative proportions set forth herein which depend upon a variety of conditions and variables. Various modifications in form and detail of the embodiments of the invention will be apparent to a person skilled in the art. It is therefore contemplated that the invention shall also cover any such modifications, variations and equivalents.

What is claimed is:

1. A method for producing a glass composition, comprising:
(a) providing cullet to a submerged combustion melter;
(b) melting said cullet in the submerged combustion melter to form a molten composition, said cullet melted with the aid of heat generated by the reaction of a fuel mixture with an oxidant, said fuel mixture comprising methane from landfill gas; and
(c) producing said glass composition from said molten composition.

2. The method of claim 1, wherein said submerged combustion melter is a submerged combustion furnace.

3. The method of claim 1, wherein said providing comprises sourcing said cullet from a mixed post-consumer stream.

4. The method of claim 1, where said cullet is finer size cullet separated from aggregate cullet.

5. The method of claim 1, wherein said landfill gas comprises at least about 30% carbon dioxide and is extracted from a landfill where anaerobic digestion produced said landfill gas from post-consumer waste.

6. The method of claim 1, wherein said fuel mixture further comprises a polymeric material.

7. The method of claim 6, wherein said polymeric material is recycled or post-consumer plastic.

8. The method of claim 7, wherein the plastic is polyethylene terephthalate.

9. The method of claim 7, wherein the plastic is high-density polyethylene.

10. The method of claim 1, wherein the glass composition is a glass fiber.

11. The method of claim 1, wherein the oxidant comprises at least about 50% by volume oxygen.

12. The method of claim 11, wherein the oxidant comprises at least about 90% by volume oxygen produced in an air separation unit.

13. The method of claim 1, wherein said producing comprises directing said molten composition to a rotary fiberizer downstream of said submerged combustion furnace.

14. The method of claim 1, wherein said producing comprises directing said molten composition to a cascade fiberizer downstream of said submerged combustion furnace.

15. The method of claim 1, further comprising adding to said molten composition one or more materials selected from the group consisting of silica sand, limestone, burnt lime, dolomitic lime, burnt dolomitic lime, soda ash, borax, colemanite, and ulexite to form a vitrifiable batch.

16. The method of claim 1, wherein said submerged combustion melter is disposed on or adjacent to a landfill.

17. A fuel mixture, comprising methane sourced from a landfill and a polymeric material sourced from recycled or post-consumer plastic, wherein said fuel mixture is capable of melting cullet upon reaction with an oxidant.

18. The fuel mixture of claim 17, wherein the oxidant comprises at least about 95% by volume oxygen.

19. The fuel mixture of claim 17, wherein said fuel mixture comprises at least about 40% by volume methane sourced from landfill gas.

20. The fuel mixture of claim 17, wherein said fuel mixture comprises at least about 30% by volume carbon dioxide.

21. A low global warming potential (GWP) glass material having a biosolubility of at least 100 ng/cm²/hr, a difference between the liquidus temperature and the high-temperature viscosity (HTV) value of at least 50° F.; a moisture resistance (G_{hyd}) more positive than −8.0 kcal/mole, produced from a vitrifiable batch comprising greater than 80% post-consumer cullet and a SiO₂ content of greater than 66% by weight.

22. The low GWP glass material of claim 21, wherein the biosolubility is at least about 200 ng/cm²/hr, and the difference in liquidus temperature and HTV value is at least about 100° F.

23. The low GWP glass material of claim 21, wherein said low GWP glass material is fibrous.

24. The low GWP glass material of claim 21, wherein the HTV value is at most about 2150° F.

25. The low GWP glass material of claim 21, wherein at least about 97% of the material is sourced from cullet.

26. The low GWP glass material of claim 21, wherein the liquidus temperature is at most about 2050° F.

27. The low GWP glass material of claim 21, wherein at least about 50 carbon dioxide equivalents are destroyed per pound of the low GWP glass material formed.

28. The low GWP glass material of claim 27, wherein greenhouse gas emission credits are obtained for destroying the carbon dioxide equivalents.

29. The low GWP glass material of claim 28, wherein the greenhouse gas emission credits are tradable on a financial exchange.

30. A fibrous glass composition comprising at least about 66% SiO₂ by weight and no more than about 2% B₂O₃ by weight.

31. The fibrous glass composition of claim 30, comprising no more than about 0.5% B₂O₃ by weight.

32. The fibrous glass composition of claim 30, comprising at least about 68% SiO₂ by weight.

33. The fibrous glass composition of claim 30, wherein said fibrous glass composition is formed from a batch comprising a lime-containing material.

34. The fibrous glass composition of claim 33, wherein the lime-containing material is quicklime, burnt dolomitic lime, or limestone.

35. The fibrous glass composition of claim 30, wherein said fibrous glass composition is formed from a batch comprising at least about 80% cullet by weight.

36. The fibrous glass composition of claim 30 wherein the glass is made from a batch comprising at least about 95% cullet by weight.

37. A system for producing a glass composition, comprising a submerged combustion melter, said submerged combustion melter in fluid communication with a source of landfill gas from a landfill.

38. The system of claim 37, further comprising a mineral source upstream of said submerged combustion melter, said mineral source supplying to said submerged combustion melter one or more materials selected from the group consisting of silica sand, limestone, burnt lime, dolomitic lime, burnt dolomitic lime, soda ash, borax, colemanite, and ulexite.

39. The system of claim 37, wherein said glass composition is fiberized from a batch comprising at least 80% cullet by weight.

40. The system of claim 39, further comprising a fiberizer downstream of said submerged combustion melter, wherein said fiberizer accepts molten glass from said submerged combustion melter and generates said glass fibers.

41. The system of claim 37, wherein said submerged combustion melter is disposed on or adjacent to a landfill.

42. The system of claim 37, wherein said submerged combustion melter is configured to accept cullet fines separated from a post-consumer cullet source.

43. A method of inerting a tropospheric ozone precursor, comprising:
(a) collecting an ozone precursor resulting from degradation of post-consumer waste;
(b) delivering said precursor to a combustion zone under a molten mass; and
(c) reacting said precursor with an oxidizer, wherein said reacting liberates heat,
wherein said heat is utilized to generate or maintain said molten mass.

44. The method of claim 43, wherein said precursor comprises methane derived from a landfill.

45. The method of claim 43, wherein said molten mass is a vitreous mass at a temperature of at least 1800° F.

46. The method of claim 43, wherein said oxidizer comprises at least about 50% oxygen gas by volume.

47. A method for forming a glass composition, comprising providing at least about 80% by weight cullet and a batch comprising a lime-containing material to a submerged combustion melter to form said glass composition.

48. The method of claim 47, wherein the lime-containing material is quicklime, burnt dolomitic lime, or limestone.
